(19) United States
(12) Patent Application Publication
(10) Pub. No.: US 2014/0092756 A1
(43) Pub. Date: Apr. 3, 2014

(54) METHODS AND APPARATUSES TO PROVIDE TIME MARKERS FOR A PACKET STREAM

(71) Applicant: Fluke Corporation, Everett, WA (US)

(72) Inventors: James W. Kisela, Snohomish, WA (US); Steve Koller, Yorktown, NY (US); William Winston, Lake Stevens, WA (US); Dan Prescott, Elbert, CO (US)

(21) Appl. No.: 13/631,760

(22) Filed: Sep. 28, 2012

(51) Int. Cl. H04L 12/26; H04L 29/02

(52) U.S. Cl. 370/252; 370/474

(57) ABSTRACT

A time marker for a data packet stream is generated. The packets are grouped into a block based on the time marker. The block of data packets is stored in a memory. A block of the data packets can be terminated based on the time marker. A block header is generated for the block. Statistics associated with the packet stream is captured based on the time marker.

### FIELD

At least some embodiments of the present invention generally relate to networking, and more particularly, to providing time markers for data streams.

### BACKGROUND

Generally, to monitor and troubleshoot network operations, network traffic packets may be captured and stored for post-processing analysis later. The volume of data that might be stored can be large in high speed, high traffic volume networks. The post-processing aspect of the analysis takes the analysis out of a real-time mode of operation.

Typically, to perform a timing analysis, a network analyzing system needs to inspect a time stamp of each data packet. Typically, to perform data traffic analysis, the system needs to inspect every data packet to compare a time stamp of the data packet against a system's time. This results in an increased requirement for storage and processing capability of the network analyzing system, and reduces network analysis efficiency.

### SUMMARY OF THE DESCRIPTION

Exemplary embodiments of methods and apparatuses provide time markers for a data packet stream are described. In at least some embodiments, a time marker for a stream of data packets is generated. The packets are grouped into a block based on the time marker. The block of data packets is stored in a memory. In one embodiment, a block of the data packets is terminated based on the time marker. In one embodiment, a block of the data packets is terminated based on a size. In one embodiment, a block header is generated for the block. The block header can include, for example, data identifying a number of the packets in the block, and data identifying a duration of the block. In one embodiment, the time marker identifies a one second time boundary. In one embodiment, statistics associated with the packet stream is captured based on the time marker.

Other features of the present invention will be apparent from the accompanying drawings and from the detailed description which follows.

### BRIEF DESCRIPTION OF DRAWINGS

Embodiments of the present invention are illustrated by way of example and not limitation in the figures of the accompanying drawings in which like references indicate similar elements.

FIG. 1 is a block diagram illustrating a data processing system according to at least some embodiments of the invention.

FIG. 2 is a block diagram of a network system according to at least some embodiments of the invention.

FIG. 3 is a block diagram of an apparatus according to at least some embodiments of the invention.

FIG. 4 shows an exemplary diagram illustrating providing time markers for a stream of data packets according to at least some embodiments of the invention.

FIG. 5 shows an exemplary diagram illustrating a memory organization according to at least some embodiments of the invention.

FIG. 6 shows an exemplary diagram illustrating a block header according to at least some embodiments of the invention.

FIG. 7 is an exemplary flowchart of a method to provide time markers for a data stream according to at least some embodiments of the invention.

### DETAILED DESCRIPTION

Exemplary embodiments of methods and apparatuses to provide time markers for a data packet stream are described. In at least some embodiments, a time marker for a data packet stream is generated. The packets are grouped into a block based on the time marker. The block of data packets is stored in a memory. In one embodiment, a block of the data packets is terminated based on the time marker. In one embodiment, a block of the data packets is terminated based on a size. In one embodiment, a block header is generated for the block. The block header can include, for example, data identifying a number of the packets in the block, and data identifying a duration of the block. In one embodiment, the time marker identifies a one second time boundary. In one embodiment, statistics associated with the packet stream is captured based on the time marker.

In at least some embodiments, a packet analyzing application needs to know when 1 second time boundaries passed, so the packet analyzing application can put statistics about the packets it sees into a correct time record. In at least some embodiments, by placing time markers into the packet stream it is analyzing, the application no longer has to break from what it is doing and go out to check with the system time stamp to see when time has passed. This makes overall packet analysis by a data processing system more efficient. These one second time boundaries further allow the processing system to handle time functions only once a second rather than performing timing analysis on every packet. The system can also take advantage of time based indexing because the mechanism allows the system to quickly determine if data packets matching a time filter are stored in a set of packets instead of having to inspect every packet.

In at least some embodiments, hardware that delivers data packets to software keeps its own timestamp counter. In at least some embodiments, the hardware time stamp counter is also synchronized with the system time stamp. In at least some embodiments, as packets are delivered from the hardware to the software, the hardware simultaneously keeps track of its time stamp counter. In at least some embodiments, when the timestamp passes a 1 second boundary, the hardware inserts a special (time) marker into the data packet stream indicating when the 1 second time boundary was crossed. As packets enter the software stack, they are further pre-aggregated into meaningful time bounded sets further decreasing the amount of processing required.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention. Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g.; computer) readable storage medium, such as, but is not limited to, any type of disk, including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a bus.

The algorithms and displays presented herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below.

In addition, embodiments of the present invention are not described with reference to any particular programming language. It will be appreciated that a variety of programming languages may be used to implement the teachings of embodiments of the invention as described herein.

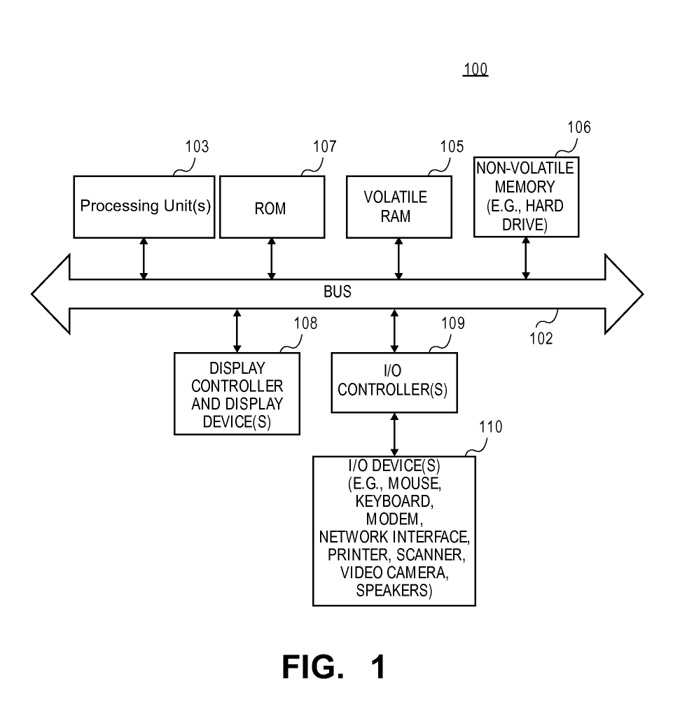

FIG. 1 shows one example of a data processing system which may be used with the embodiments of the present invention. Note that while FIG. 1 illustrates various components of a computer system, it is not intended to represent any particular architecture or manner of interconnecting the components as such details are not germane to the embodiments of the present invention. It will also be appreciated that network computers and other data processing systems which have fewer components or perhaps more components may also be used with the embodiments of the present invention.

Generally, a network refers to a collection of computers and other hardware components interconnected to share resources and information. Networks may be classified according to a wide variety of characteristics, such as the medium used to transport the data, communications protocol used, scale, topology, and organizational scope. Communications protocols define the rules and data formats for exchanging information in a computer network, and provide the basis for network programming. Well-known communications protocols include Ethernet, a hardware and link layer standard that is ubiquitous in local area networks, and the Internet protocol (IP) suite, which defines a set of protocols for internetworking, i.e. for data communication between multiple networks, as well as host-to-host data transfer e.g., Transmission Control Protocol (TCP), and application-specific data transmission formats, for example, Hypertext Transfer Protocol (HTTP). Methods and apparatuses to provide time markers for a packet stream described herein can be used for any of networks, protocols, and data formats.

As shown in FIG. 1, the data processing system 100, which is a form of a data processing system, includes a bus 102 which is coupled to one or more processing units 103, a ROM 107, volatile RAM 105, and a non-volatile memory 106. One or more processing units 103, may include, for example, a G3 or G4 microprocessor from Motorola, Inc. or IBM, may be coupled to a cache memory (not shown) or may include a network processor implemented in a field-programmable gate array (FPGA). The bus 102 interconnects these various components together and also interconnects these components 103, 107, 105, and 106 to a display controller and display device(s) 108 and to peripheral devices such as input/output (I/O) devices which may be mice, keyboards, modems, network interfaces, printers, scanners, video cameras, speakers, and other devices which are well known in the art. Typically, the input/output devices 110 are coupled to the system through input/output controllers 109. The volatile RAM 105 is typically implemented as dynamic RAM (DRAM) which requires power continually in order to refresh or maintain the data in the memory. The non-volatile memory 106 is typically a magnetic hard drive or a magnetic optical drive or an optical drive or a DVD RAM or other type of memory systems which maintain data even after power is removed from the system. Typically, the non-volatile memory will also be a random access memory although this is not required. In at least some embodiments, data processing system 100 includes a power supply (not shown) coupled to the one or more processing units 103 which may include a battery and/or AC power supplies.

While FIG. 1 shows that the non-volatile memory is a local device coupled directly to the rest of the components in the data processing system, it will be appreciated that the embodiments of the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the I/O controller 109 includes a USB (Universal Serial Bus) adapter for controlling USB peripherals, and/or an IEEE-1394 bus adapter for controlling IEEE-1394 peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 107, volatile RAM 105, non-volatile memory 106, or a remote storage device. In various embodiments, hardwired circuitry may be used in combination with software instructions to implement embodiments of the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by one or more processing units 103, e.g., a microprocessor, a field-programmable gate array (FPGA) and/or a microcontroller.

A machine readable medium can be used to store software and data which when executed by a data processing system causes the system to perform various methods of the present invention. This executable software and data may be stored in various places including for example ROM 107, volatile RAM 105, and non-volatile memory 106 as shown in FIG. 1. Portions of this software and/or data may be stored in any one of these storage devices.

Thus, a machine readable medium includes any mechanism that provides (i.e., stores and/or transmits) information in a form accessible by a machine (e.g.; a computer, network device, cellular phone, personal digital assistant, manufacturing tool, any device with a set of one or more processors, etc.). For example, a machine readable medium includes recordable/non-recordable media (e.g., read only memory (ROM); random access memory (RAM); magnetic disk storage media; optical storage media; flash memory devices; and the like.

The methods of the present invention can be implemented using a dedicated hardware (e.g., using Field Programmable Gate Arrays (FPGAs), or Application Specific Integrated Circuit (ASIC) or shared circuitry (e.g., microprocessors or microcontrollers under control of program instructions stored in a machine readable medium). The methods of the present invention can also be implemented as computer instructions for execution on a data processing system, such as system 100 of FIG. 1.

Generally, a FPGA is an integrated circuit designed to be configured by a customer or a designer after manufacturing. The FPGA configuration is generally specified using a hardware description language (HDL). FPGAs can be used to implement a logical function.

FPGAs typically contain programmable logic components (“logic blocks”), and a hierarchy of reconfigurable interconnects to connect the blocks. In most FPGAs, the logic blocks also include memory elements, which may be simple flip-flops or more complete blocks of memory.

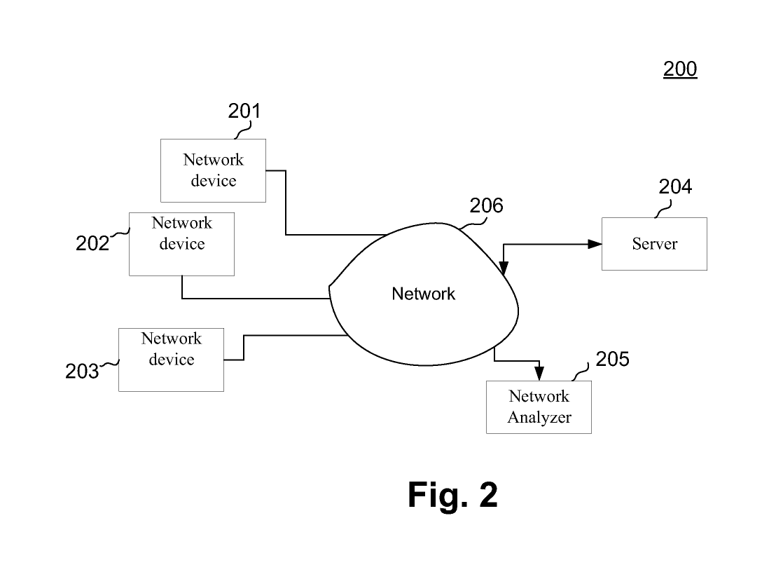

FIG. 2 is a block diagram of a network system according to at least some embodiments of the invention. As shown in FIG. 2, a network system 200 comprises network devices, such as network devices 201, 202, and 203, a server 204 which communicate over a network 206 by sending and receiving network traffic. The traffic may be sent in a packet form, with varying protocols and formatting thereof. As shown in FIG. 2, a network analyzer 205 is also connected to the network 206. Network analyzer 205 can include a remote network analyzer interface (not shown) that enables a user to interact with the network analyzer to operate the analyzer and obtain data therefrom remotely from the physical location of the analyzer. The network analyzer comprises hardware and software, CPU, memory, interfaces and the like to operate to connect to and monitor traffic on the network, as well as performing various testing and measurement operations, transmitting and receiving data and the like. The remote network analyzer typically is operated by running on a computer or workstation interfaced with the network.

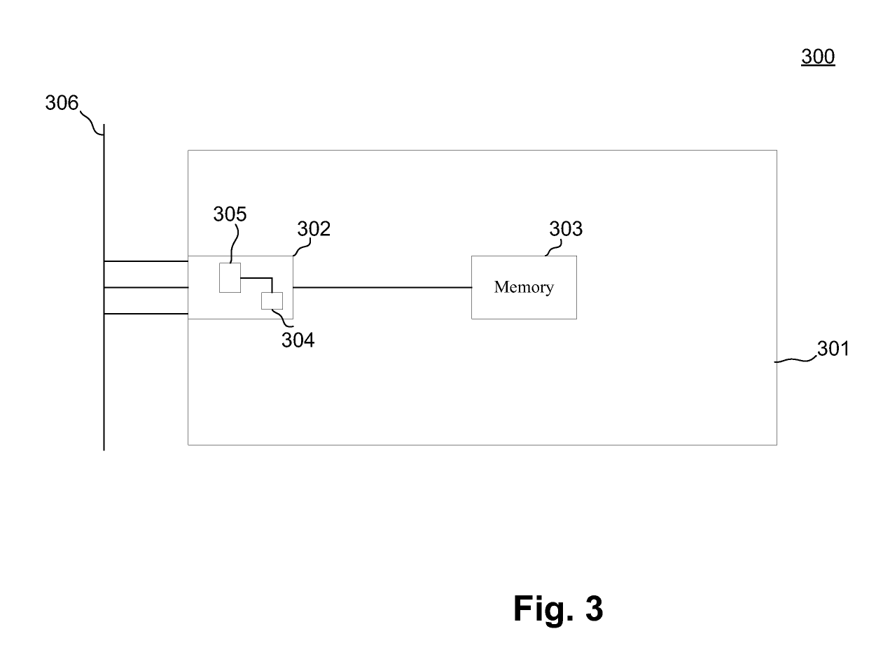

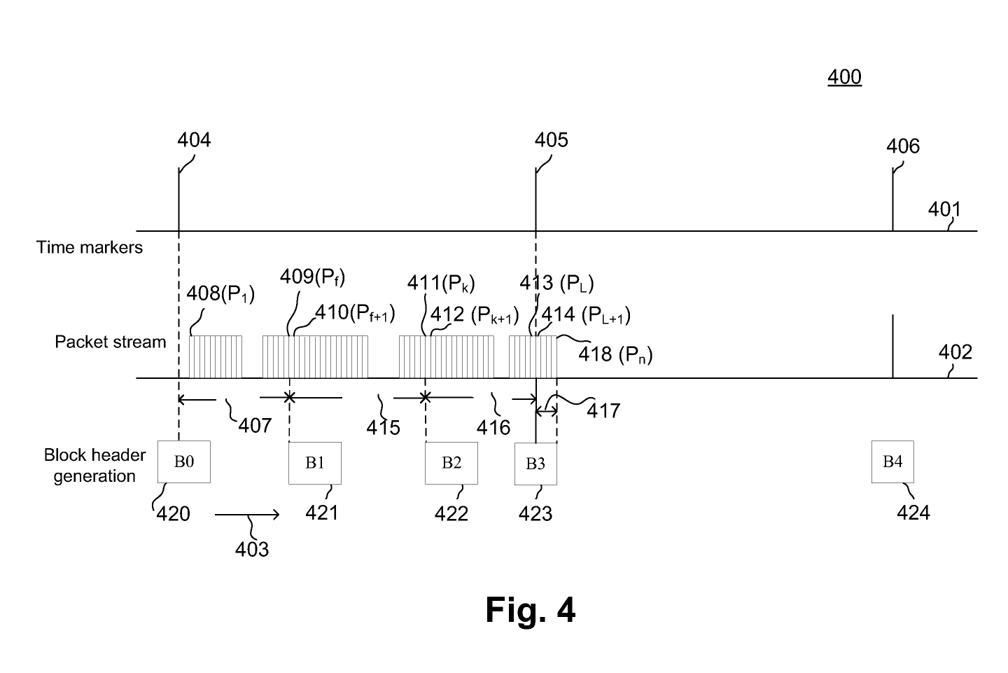

FIG. 3 is a block diagram of an apparatus according to at least some embodiments of the invention. As shown in FIG. 3 an apparatus 300 includes a network processing unit 302 coupled to a memory 303 on a high-performance data processing system 301. The high-performance data processing system 301 can be a high-performance server, such as server 204. In at least some embodiments, processing unit 302 is configured to generate a time marker for the packet stream received from network 306. In at least some embodiments, the processing unit 302 is configured to group the data packets into a block based on the time marker. In at least some embodiments, processing unit 302 is configured to store the blocks of data packets in memory 303. In at least some embodiments, the processing unit 302 is further configured to terminate the block of data packets based on the time marker. In at least some embodiments, the processing unit 302 is further configured to terminate the block of data packets based on a block size. In at least some embodiments, the processing unit 302 is further configured to generate a block header for the block. The block header can include data identifying a number of the packets in the block, and a duration of the block, as described in further detail below. In at least some embodiments, time marker identifies a one second time boundary for a data packet stream. In at least some embodiments, the processing unit 302 is further configured to capture statistics associated with the packet stream based on the time marker. At least some embodiments of operations of the processing unit 302 are described in further detail in FIGS. 4-7.

Referring back to FIG. 3, network processing unit 302 includes a logic unit 305 coupled to a time counter 304. In at least some embodiments, network processing unit 302 is a network monitoring card that plugs, for example, into a Peripheral Component Interconnect Express (PCIe) slot in a high-performance server, to filter, aggregate, and buffer traffic from a network, such as a network 306. In at least some embodiments, network processing unit 302 includes a FPGA. In at least some embodiments, blocks of data packets grouped based on time markers are supplied from the network processing unit 302 to a memory 303.

In at least some embodiments, network processing unit 302 comprises a custom hardware that receives the packets coming over the network. In at least some embodiments, network processing unit has a function to keep track of the current time and insert a time marker into the data stream at every second boundary so that a downstream software knows that a second boundary has passed. Then all the next packets or events will be associated with that time second and then as the next second boundary passes then those packets are associated with the next time boundary. This allows the software downstream to not have to do many look ups or checks with the system operating system to figure out in which time interval the events happened.

In at least some embodiments, unit 302 has time counter 304 that counts current time and generates time markers to actually insert these time markers into the data stream that goes to the rest of the system or the software. The time markers are directly inserted into the data stream that provides an in-band messaging scheme. The time marker directly inserted into the data stream are formatted into a format complying with the software downstream.

That is, the time markers are inserted into the data stream in such a way that the format is not disturbed and this format is going to be understood by the downstream software.

FIG. 4 shows an exemplary diagram 400 illustrating providing time markers for a stream of data packets according to at least some embodiments of the invention. As shown in FIG. 4, time markers, such as time markers 404, 405, and 406, are generated along a timeline 401 for a packet stream 402. In at least some embodiments, time markers identify a predetermined time boundary for a packet stream. In at least some embodiments, time markers are generated at a predetermined time interval, e.g., 1 second time interval, or any other predetermined time interval.

Packets of a packet stream 402 arriving along a time line 401 are grouped into corresponding blocks. In at least some embodiments, the size of the block of packets does not exceed a predetermined upper threshold, e.g., 1 Megabyte or any other predetermined upper threshold size. In at least some embodiments, the size of the block of packets is not smaller than a predetermined lower threshold, e.g., 512 bytes, or any other predetermined lower threshold size.

As shown in FIG. 4, all data packets starting from a packet 408 (Pl) and ending with a packet 409 (P_{f}, where f can be any integer number, e.g., 1904) are grouped into a block 407. As shown in FIG. 4, all data packets starting from a packet 410 (Pf+1) and ending with a packet 411 (Pₖ, where k can be any integer number, e.g., 4908) are grouped into a block 415. All data packets starting from a packet 412 (Pk+1) and ending with a packet 413 (P₁, where 1 can be any integer number, e.g., 6786) are grouped into a block 416. All data packets starting from a packet 414 (Pl+1) and ending with a packet 418 (Pₙ, where n can be any integer number, e.g., 7706) are grouped into a block 417. In at least some embodiments, a packet block is terminated by generating a block header.

As shown in FIG. 4, block headers are generated 403 along a time line 401. As shown in FIG. 4, a block header 420 is generated at a time marker 404, a block header 423 is generated at a time marker 405, and a block header 424 is generated at a time marker 406. As shown in FIG. 4, a block header 421 (B1) is generated after block 407 reaches a predetermined upper threshold size. A block header 422 (B2) is generated after block 415 reaches a predetermined upper threshold size. The predetermined size can be e.g., 1 Mbyte, or any other predetermined size.

In at least some embodiments, a block header is inserted at the beginning of the block. In at least some embodiments, a block header includes data identifying a number of the packets in the block, and a duration of the block. As shown in FIG. 4, the sizes of blocks 416 and 417 are smaller than a predetermined upper threshold size, e.g., 1 Mbyte. In at least some embodiments, the statistics of the packets in a packet stream, such as packet stream 402, is captured based on the time markers, e.g., time markers 404, 405, and 406. In at least some embodiments, the block headers appended to the corresponding blocks are stored in a memory.

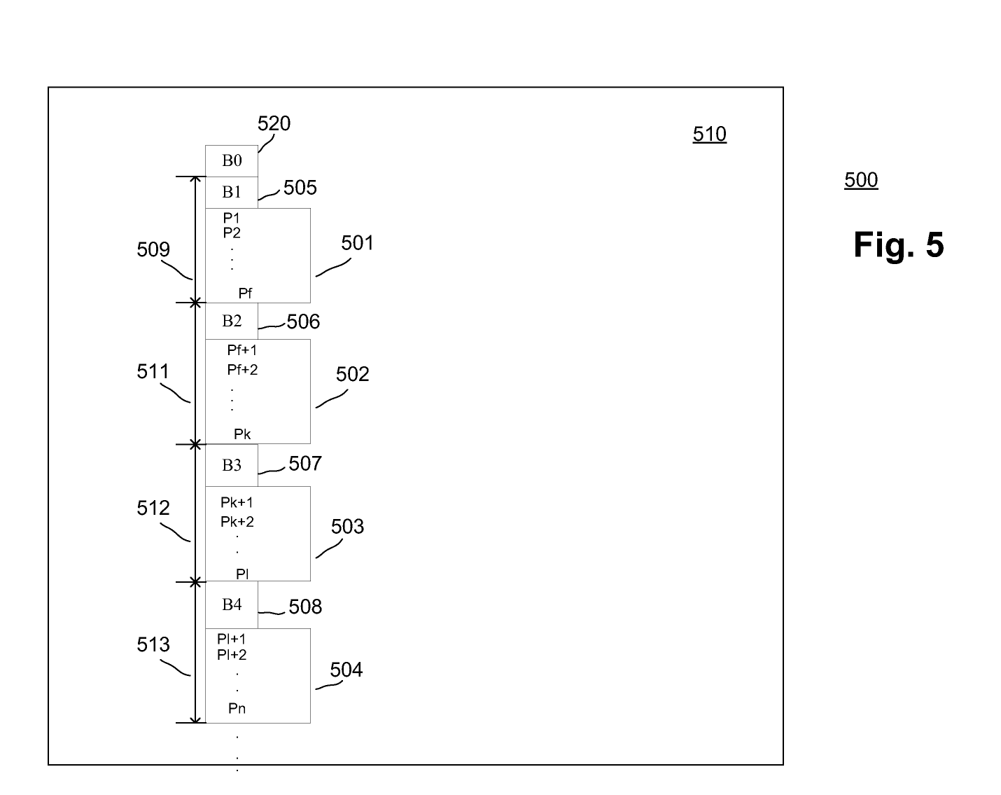

FIG. 5 shows an exemplary diagram 500 illustrating a memory organization according to at least some embodiments of the invention. As shown in FIG. 5, blocks of packets, such as blocks 501, 502, 503, and 504 are stored in a memory 510. In at least some embodiments, memory 510 is located at a host server. In at least some embodiments, blocks 501, 502, 503, and 504 correspond to blocks 407, 415, 416, and 417 of FIG. 4. As shown in FIG. 5, block headers, such as block headers 520, 505, 506, 507, and 508, are inserted at the beginning of the corresponding blocks. In at least some embodiments, block headers 520, 505, 506, 507, and 508 correspond to block headers 420, 421, 422, 423, and 424 of FIG. 4. In at least some embodiments, each of the blocks 501 and 502 has an upper threshold size (e.g., 1 Mbyte). In at least some embodiments, each of the blocks 503 and 504 has a size that is smaller than an upper threshold size (e.g., 1 Mbyte).

Referring to FIGS. 5 and 4, block 501 starts with a packet Pl and ends with a packet Pf (e.g., packet 409). In one embodiment, the size of block 501 is 1 Mbyte. Block 502 starts with a next packet Pf+1 (e.g., packet 410) and ends with a packet Pk (e.g., packet 411). In one embodiment, the size of block 502 is 1 Mbyte. Block 503 starts with a next packet Pk+1 (e.g., packet 412) and ends with a packet Pl (e.g., packet 413). In one embodiment, the size of block 503 is 600 Kbytes. Block 504 starts with a next packet Pl+1 (e.g., packet 414) and ends with a packet Pn (e.g., packet 418). In one embodiment, the size of block 504 is 150 Kbytes.

That is, the packets are grouped and stored within a large block of memory. So a downstream network analyzing application does not process each packet as it comes in; the network analyzing application will wait until a whole block of packets is stored into a host memory. The network application keeps track of whether or not it has a new block to read by checking a counter, such as counter 304.

In one embodiment, after storing a predetermined number of bytes of packets into a memory, a block header is generated. In one embodiment, a block header is generated and stored in a memory when a time marker is passed (e.g., every predetermined amount of seconds). For example, even if the packets are not received, block headers are generated once every predetermined time interval (e.g., every second) and are stored into a memory. In at least some embodiments, time markers are implemented as being embedded in a header block memory mechanism to store packets. In at least some embodiments, individual packets are received and grouped into blocks and stored in a host memory by a custom hardware, such as unit 302.

In at least some embodiments, memory 510 contains three levels of data: packet data, a packet report on top of the packet data, and a block header on top of the packet report. In at least some embodiments, packet data contain packet itself having data bytes. In at least some embodiments, the packet report header is generated for each packet. Generally, the packet report header contains data describing the packet, for example, an indication of what is in the packet. In at least some embodiments, the packet report header has a timestamp of the packet, an indication of number of bytes in the packet, and other data to assist processing the packet. A block header is generated on top of the packet report for each block stored in a memory.

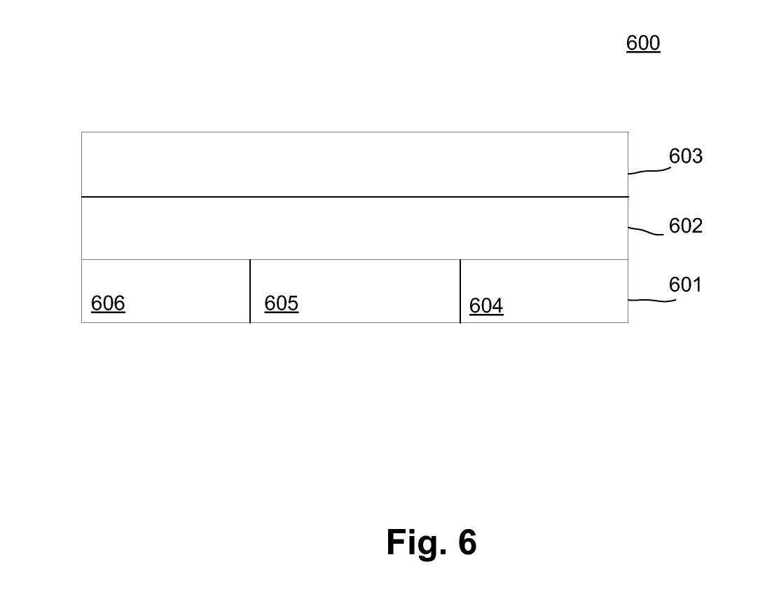

FIG. 6 shows an exemplary diagram illustrating a block header 600 according to at least some embodiments of the invention. As shown in FIG. 6, block header 600 contains lines, such as lines 601, 602, and 603. In at least some embodiments, each of the lines of the block header 600 has 8 bytes. As shown in FIG. 6, line 601 includes fields 604, 605, and 606. For example, field 604 can indicate a number of packets are in the block, field 605 can indicate a size of the block, field 606 can indicate a number of packets in the block. For example, line 602 can contain a field indicating a start timestamp of the block of packets. For example, line 603 can contain a field indicating an end timestamp of the block of packets.

In at least some embodiments, the block header is inserted at the beginning of a block. In at least some embodiments, the block header has information regarding how many packets are stored in that block. In at least some embodiments, the block header has a time stamp information, start of block, end of block timestamp information.

In at least some embodiments, the block header has the time stamp of a first packet in the block and the time stamp of a last packet in the block. In at least some embodiments, the block header is generated each time when a time boundary is passed (e.g., every second). In at least some embodiments, a block is terminated and a new block header is generated on the time boundary.

A block header is generated on the time boundary acts as a time marker inserted directly into the data stream. Inserting the time markers into the data stream increases the efficiency and simplifies packet stream analysis for a packet analyzing application.

In at least some embodiments, a processing unit including hardware, such as unit 302 of FIG. 3 actually gathers the statistics and sends it into a host memory, such as memory 303 on a one-second basis. In at least some embodiments, when a one-second marker is generated a block of the received packets is terminated, and the block header is generated. In at least some embodiments, the block header contains timing information associated with the statistics of the packets. That is, an interrupt is generated at a time boundary, so that a packet analyzing application can read all of the statistics and correlate the statistics to the specific time interval based (e.g., 1 second) block.

Embodiments described herein make the packet analyzing more efficient. Because the time markers are added into the data stream, the packet analyzing application does not have to look somewhere else to see which packets are associated with each time bracket. The packets being analyzed have already been pre-categorized based on the time boundaries for efficient retrieval from the memory.

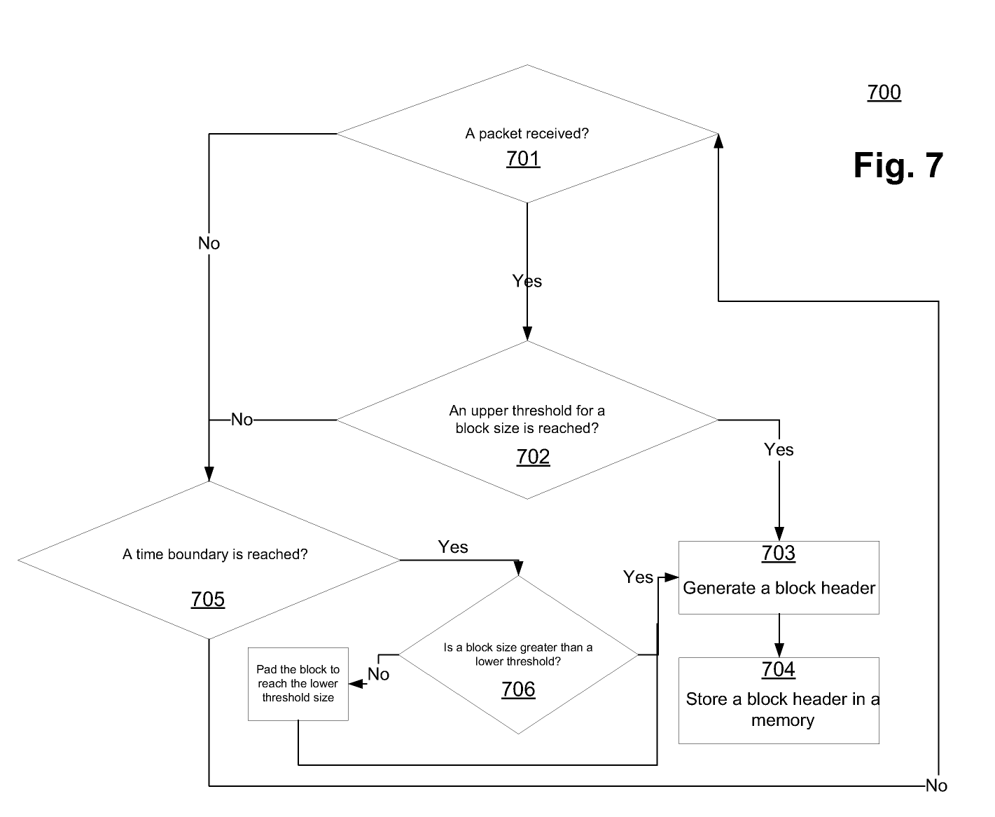

FIG. 7 is an exemplary flowchart of a method 700 to provide time markers for a data stream according to at least some embodiments of the invention. At operation 701 it is determined if a data packet is received. If the packet is received, method 700 continues with operation 702 that involves determining if an upper threshold for a block size has been reached. If the upper threshold for the block size has been reached, a block is terminated by generating a block header at operation 703, as described above. At operation 704 a block header is stored in a memory, as described above. If the packet is not received, method 700 continues with operation 705 involving determining if a time marker indentifying a time boundary has been reached. If the time boundary has been reached, at operation 706 it is determined if a lower threshold for a block size has been reached. In at least some embodiments, the lower threshold is smaller than the upper threshold. For example, the lower threshold can be 512 bytes, or any other size less than an upper threshold size, as described above. If the lower threshold has been reached, a block header is generated at operation 703, as described above. If the lower threshold has not been reached, the block is padded by, e.g., empty packets to reach the lower threshold size, and then a block header is generated at operation 703. Returning back to operation 702, if it is determined that an upper threshold for a block size has not been reached, method 700 goes to operation 705. If it is determined at 705 that a time boundary has not been reached, method 700 returns to operation 701.

Inserting time markers on a time boundary for a data stream provides a mechanism for timing, for aggregating packets and for collecting statistics about the data stream even when there are no packets arriving. In at least some embodiments, inserting the time markers is a synchronized event that occurs on a time boundary so that even when no packets are received, statistics and information about the data stream on a predetermined time interval can still be collected.

For example, a packet analyzing application measures an application response time and for example, it takes 10 seconds for an event to occur. The typical application won't know that until the last packet comes in. If the packet never comes in the packet analyzing application can never have an updated statistic. By inserting time markers at a predetermined time interval into the data stream constantly as described herein, the statistics over that time interval can be dynamically obtained without a need to wait for a last packet to arrive. The processing overhead is greatly reduced by providing the time markers at a predetermined time interval, because the time interval does not need to be re-calculated each time the packet arrives.

Currently, if there's a time interval where packets don't arrive, a packet analyzing application cannot update the packet statistics. By inserting time markers into a data stream as described herein, packet statistics is updated based on the time mechanism (clock). In one embodiment, the same hardware that's providing a time stamp for each packet in a packet report also provides time markers (e.g., a predetermined interval ticks) for the statistics. That is, a real time information analysis of the traffic during a certain amount of time can be obtained based on the data that have been pre-organized based on the time markers. The network analyzing application doesn't need to look at every received packet or wait until the last packet comes to obtain the packet statistics.

In the foregoing specification, embodiments of the invention have been described with reference to specific exemplary embodiments thereof. It will be evident that various modifications may be made thereto without departing from the broader spirit and scope of the embodiments of the invention. The specification and drawings are, accordingly, to be regarded in an illustrative sense rather than a restrictive sense.

What is claimed is:

1. A method to provide time markers for a stream of data packets, comprising:
generating a time marker for the packet stream;
grouping the packets into a block based on the time marker; and
storing the block in a memory.

2. The method of claim 1, further comprising
terminating the block based on the time marker.

3. The method of claim 1, further comprising
terminating the block based on a size.

4. The method of claim 1, further comprising
generating a block header for the block, wherein the block header includes data
identifying a number of the packets in the block, and a duration of the block.

5. The method of claim 1, wherein the time marker identifies a one second time boundary.

6. The method of claim 1, further comprising
capturing statistics associated with the packet stream based on the time marker.

7. A non-transitory machine readable storage medium that has stored instructions which when executed cause a data processing system to perform operations comprising:
generating a time marker for the packet stream;
grouping the packets into a block based on the time marker; and
storing the block in a memory.

8. The non-transitory machine readable storage medium of claim 7, further comprising instructions which when executed cause the data processing system to perform operations comprising terminating the block based on the time marker.

9. The non-transitory machine readable storage medium of claim 7, further comprising instructions which when executed cause the data processing system to perform operations comprising
terminating the block based on a size.

10. The non-transitory machine readable storage medium of claim 7, further comprising instructions which when executed cause the data processing system to perform operations comprising generating a block header for the block, wherein the block header includes data identifying a number of the packets in the block, and a duration of the block.

11. The non-transitory machine readable storage medium of claim 7, wherein the time marker identifies a one second time boundary.

12. The non-transitory machine readable storage medium of claim 7, instructions which when executed cause the data processing system to perform operations comprising capturing statistics associated with the packet stream based on the time marker.

13. An apparatus to provide time markers for a stream of data packets comprising:
a memory; and
a processing unit coupled to the memory, wherein the processing unit is configured to generate a time marker for the packet stream, the processing unit configured to group the packets into a block based on the time marker; and the processing unit configured to store the block in a memory.

14. The apparatus of claim 13, wherein the processing unit is further configured to terminate the block based on the time marker.

15. The apparatus of claim 13, wherein the processing unit is further configured to terminate the block based on a size.

16. The apparatus of claim 13, wherein the processing unit is further configured to generate a block header for the block, wherein the block header includes data identifying a number of the packets in the block, and a duration of the block.

17. The apparatus of claim 13, wherein the time marker identifies a one second time boundary.

18. The apparatus of claim 13, wherein the processing unit is further configured to capture statistics associated with the packet stream based on the time marker.
